(19) United States
(12) Patent Application Publication
(10) Pub. No.: US 2025/0079448 A1
(43) Pub. Date: Mar. 6, 2025

(54) NEGATIVE ELECTRODE ACTIVE MATERIAL AND RECHARGEABLE LITHIUM BATTERY INCLUDING SAME

(71) Applicants: SAMSUNG SDI CO., LTD., Yongin-si (KR); IUCF-HYU (Industry-University Cooperation Foundation Hanyang University), Seoul (KR)

(72) Inventors: SUNIL PARK, Yongin-si (KR); Hansu KIM, Seoul (KR); Donghyeok MA, Seoul (KR); Mi YU, Seoul (KR); Youngugk KIM, Yongin-si (KR); Deok-Hyun KIM, Yongin-si (KR); Ilyoung CHOI, Yongin-si (KR)

(21) Appl. No.: 18/734,018

(22) Filed: Jun. 5, 2024

(30) Foreign Application Priority Data
Aug. 28, 2023 (KR) 10-2023-0112990

(51) Int. Cl. H01M 4/36; H01M 4/02; H01M 4/38; H01M 4/485; H01M 4/583; H01M 10/0525

(52) U.S. Cl. CPC H01M 4/366; H01M 4/386; H01M 4/485; H01M 4/583; H01M 10/0525; H01M 2004/021; H01M 2004/027

(57) ABSTRACT

A negative electrode active material and a rechargeable lithium battery including the negative electrode active material, the negative electrode active material includes a core including a carbon material, a silicon material, or a combination thereof; and a shell on a surface of the core, the shell including Si and LiₓSiO_{y}, in which 1≤x≤3 and 1≤y≤6.

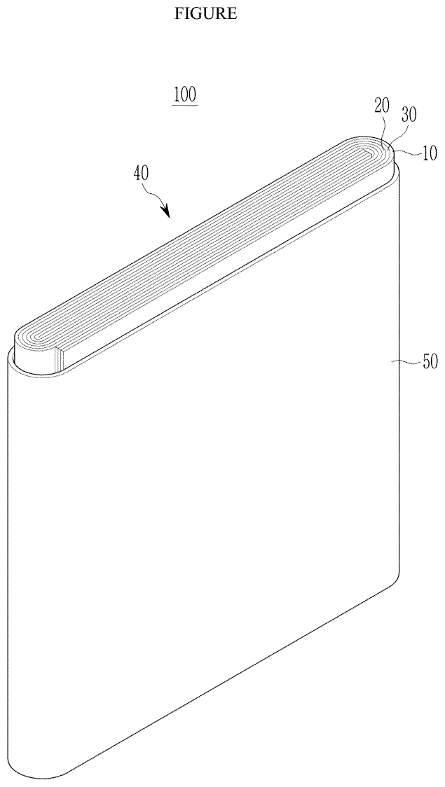

### CROSS-REFERENCE TO RELATED APPLICATION

This application claims priority to and the benefit of Korean Patent Application No. 10-2023-0112990 filed in the Korean Intellectual Property Office on Aug. 28, 2023, the entire contents of which are incorporated herein by reference.

### BACKGROUND

### 1. Field

Embodiments relate to a negative electrode active material and a rechargeable lithium battery including the same.

### 2. Description of the Related Art

Growth of the demand for electric vehicles may increase the demand of rechargeable batteries. The demand for a high energy density and fast charging speed may be increased.

A rechargeable lithium battery may be used as such a rechargeable battery. A rechargeable lithium battery may include a positive electrode, a negative electrode, and an electrolyte.

### SUMMARY

The embodiments may be realized by providing a negative electrode active material including a core including a carbon material, a silicon material, or a combination thereof; and a shell on a surface of the core, the shell including Si and LiₓSiO_{y}, in which 1≤x≤3 and 1≤y≤6.

The shell may further include SiO_{z}, in which 0<z≤2.

The shell may be on the surface of the core in a form of an island-type or a layer-type.

The shell may be on the surface of the core in the form of the island-type.

The negative electrode active material may have a pH of about 7 or less.

The carbon material may include amorphous carbon, crystalline carbon, or a combination thereof.

The silicon material may include a Si—C composite.

The Si—C composite may include silicon particles, and an amorphous carbon layer on a surface of the silicon particles.

The Si—C composite may include a secondary particle in which silicon primary particles are agglomerated, and an amorphous carbon coating layer on a surface of the secondary particle.

The negative electrode active material may further include an amorphous carbon coating layer on the shell.

The shell may have a thickness of about 100 nm to about 500 nm.

The shell may be porous.

A weight ratio of the LiₓSiO_{y} and Si may be about 1:99 to about 77:23.

A weight ratio of the LiₓSiO_{y} and Si may be about 1:99 to about 75:25.

An amount of the LiₓSiO_{y} may be about 0.1 wt % to about 15 wt %, based on a total weight of the negative electrode active material.

An amount of the LiₓSiO_{y} may be about 0.1 wt % to about 10 wt % based on a total weight of the negative electrode active material.

The embodiments may be realized by providing a rechargeable lithium battery including a negative electrode including the negative electrode active material according to an embodiment; a positive electrode; and an electrolyte.

### BRIEF DESCRIPTION OF THE DRAWING

Features will be apparent to those of skill in the art by describing in detail exemplary embodiments with reference to the attached drawing in which:

the FIGURE is a cross-sectional view schematically showing rechargeable lithium batteries according to some embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. Like reference numerals refer to like elements throughout.

The term “combination thereof” may include a mixture, a laminate, a complex, a copolymer, an alloy, a blend, a reactant of constituents.

The term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

As used herein, unless explicitly described to the contrary, the word “comprise” and variations such as “comprises” or “comprising” will be understood to imply the inclusion of stated elements but not the exclusion of any other element.

The drawings show that the thickness is enlarged in order to clearly show the various layers and regions, and the same reference numerals are given to similar parts throughout the specification. If an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

In some embodiments, herein, “layer” includes a shape totally formed on the entire surface or a shape partial surface, when viewed from a plane view.

In the present disclosure, “or” is not to be construed in an exclusive sense, for example, “A or B” may be interpreted to include A, B, A+B, or the like.

The term “thickness” may be measured through a photograph taken with an optical microscope such as a scanning electron microscope, for example.

In the present disclosure, when a definition is not otherwise provided, such a particle diameter or size indicates an average particle diameter. An average particle diameter indicates an average particle diameter (D50) where a cumulative volume is about 50 volume % in a particle size distribution. If particles are spherical, “diameter” indicates a particle diameter or an average particle diameter, and when the particles are non-spherical, the “diameter” indicates a long axis length or an average long axis length. The particle size (D50) may be measured by a method well known to those skilled in the art, for example, by a particle size analyzer, or by a transmission electron microscopic image, a scanning electron microscopic image), or a field emission scanning electron microscopy (FE-SEM). In another embodiment, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

A negative electrode active material according to some embodiments may include, e.g., a core including a carbon material, a silicon material, or a combination thereof; and a shell on a surface of the core. The shell may include, e.g., Si and LiₓSiO_{y} (in which 1≤x≤3 and 1≤y≤6).

In an implementation, the negative electrode active material according to some embodiments may include a shell including a silicate compound represented by LiₓSiO_{y} (1≤x≤3, 1≤y≤6) and Si, charge and discharge efficiency may be improved, and the lithium ion conductivity may be improved. The enhanced energy density and high-rate charging characteristics may also be realized. If the silicate compound were to be included in the core, e.g., if it were included in both the core and the shell to thus be distributed throughout the negative electrode active material, the electrical conductivity could be reduced and the cycle-life may be deteriorated.

The silicate compound may include, e.g., Li₂SiO₃, Li₂Si₂O₅ or a combination thereof.

The shell according to one or more embodiments may further include, e.g., SiO_{z} (0<z≤2). In an implementation, the shell may further include SiO_{z} (0<z≤2), and energy density may be enhanced.

In an implementation, the shell may be discontinuously disposed or present on the surface of the core in a form of an island-type, or may be continuously disposed or present on the surface of the core in a form of a layer-type (e.g., a partial or complete layer continuously on the core). In an implementation, some of the surface of the core may not be covered by the shell to thus be partially exposed, or the entire surface of the core may be covered by the shell to thus be unexposed. In an implementation, the shell may be disposed in the form of the island-type, and superior conductivity may be exhibited, thereby demonstrating more excellent rate capability and efficiency characteristic.

In an implementation, a weight ratio of the LiₓSiO_{y} (in which 1≤x≤3 and 1≤y≤6) and Si may be a weight ratio of, e.g., about 1:99 to about 77:23, or about 1:99 to about 75:25, or about 1:99 to about 80:20. Maintaining the weight ratio of the LiₓSiO_{y} (1≤x≤3 and 1≤y≤6) and Si within the ranges may help ensure that there may be an advantage in that high capacity and cycle characteristic may be appropriately harmonized.

In an implementation, an amount of the LiₓSiO_{y} (1≤x≤3 and 1≤y≤6) may be, based on the total weight of the negative electrode active material, about 0.1 wt % to about 15 wt %, about 0.1 wt % to about 10 wt %, or about 0.1 wt % to about 5 wt %. Maintaining the amount of the LiₓSiO_{y} (1≤x≤3 and 1≤y≤6) within the ranges may have the advantages in which high initial efficiency may be exhibited and the cycle characteristic may be enhanced.

A thickness of the shell may be, e.g., about 100 nm to about 500 nm, about 100 nm to about 450 nm, or about 100 nm to about 400 nm. Maintaining the thickness of the shell within the ranges may help ensure that energy density and high rate charging ability may be sufficiently improved without deterioration of electrical conductivity.

In an implementation, the shell may be porous (e.g., may include pores therein). In an implementation, the shell may include pores, there may be no irreversible phase which does not react with lithium, and thus, may be advantageous in terms of an energy density compared to the shell being a dense layer.

In the negative electrode active material according to one or more embodiments, the core may include a carbon material or a silicon material, or a combination of the carbon material and the silicon material. It may be also at least one thereof. The carbon material may include, e.g., crystalline carbon. The crystalline carbon may include, e.g., graphite such as an unspecified shaped, sheet shaped, flake shaped, spherical shaped, or fiber shaped artificial graphite or natural graphite.

The silicon material may include, e.g., a Si—C composite. The Si—C composite may include silicon particles and an amorphous carbon coated on the surface of the silicon particles, e.g., may include silicon particles and an amorphous carbon coating layer coated on the surface of the silicon particles. In an implementation, the silicon-carbon composite may include secondary particles where silicon primary particles are agglomerated, and an amorphous carbon coating layer on the surface of the secondary particles. The amorphous carbon may be between the silicon primary particles, e.g., to coat on the silicon primary particles. The Si—C composite may also include a core in which silicon particles are distributed in an amorphous carbon matrix and an amorphous carbon coating layer coated on a surface of the core.

The secondary particle may be at the center of the Si—C composite, so it may refer as a core or a center part. The amorphous carbon coating layer may be referred to as an outer part or a shell.

The silicon particles or the silicon primary particles may be nano silicon particles. A particle diameter of the nano silicon particles may be, e.g., about 10 nm to about 1,000 nm, about 20 nm to about 900 nm, about 20 nm to about 800 nm, about 20 nm to about 500 nm, about 20 nm to about 300 nm, or about 20 nm to about 150 nm. Maintaining the average particle diameter of the silicon particles within the ranges may help ensure that the extreme volume expansion caused during charge and discharge may be suppressed, and a breakage of the conductive path due to crushing of particle may be prevented.

A mixing ratio of the silicon particle and amorphous carbon may be a weight ratio of about 1:99 to about 60:40.

In an implementation, the secondary particles or the core may further include crystalline carbon. In an implementation, the silicon-carbon composite may further include crystalline carbon, and the Si—C composite may include secondary particles where the silicon primary particles and crystalline carbon are agglomerated and an amorphous carbon coating layer on the surface of the secondary particles. The surface of the silicon primary particles may also be coated with amorphous carbon.

In an implementation, the Si—C may include silicon particles, crystalline carbon, and amorphous carbon, an amount of the amorphous carbon may be about 30 wt % to 70 wt % based on the total weight of the Si—C composite, and an amount of the crystalline carbon may be about 1 wt % to about 20 wt % based on the total weight of the Si—C composite. An amount of the silicon particles may be, e.g., based on the total weight of the Si—C composite, about 20 wt % to about 70 wt %, or about 30 wt % to about 60 wt %.

The particle diameter of the Si—C composite may be appropriately or suitably adjusted.

In an implementation, the amorphous carbon may surround the secondary surface, and a thickness may be suitably adjusted, e.g., may be about 5 nm to about 100 nm.

The amorphous carbon may include, e.g., pitch carbon, soft carbon, hard carbon, mesophase pitch carbide, sintered coke, a carbon fiber, or a combination thereof. The crystalline carbon may be, e.g., unspecified shaped, sheet, flake, spherical, or fiber shaped natural graphite or artificial graphite.

In an implementation, the negative electrode active material may further include an amorphous carbon coating layer on the shell. In an implementation, the amorphous carbon coating layer may be further included on the shell, and electrical conductivity may be further increased. A thickness of the amorphous carbon coating layer may be, e.g., about 0.1 nm to about 50 nm, about 0.5 nm to about 10 nm, or about 1 nm to about 5 nm.

The negative electrode active material according to some embodiments may have a pH of, e.g., about 7 or less, about 3 to about 7, or about 5 to about 6. In an implementation, the negative electrode active material according to one or more embodiments may have acidity or may be acidic, which may help improve adhesion strength to the binder compared to a basic negative electrode active material having a pH of greater than 7, during the preparation of the electrode.

Such a negative electrode active material according to one or more embodiments may be prepared by the following procedures.

A carbon material may be added to an acidic solvent, and then a hydrogen silsesquioxane precursor may be added to the resulting mixed liquid.

The acidic solvent may include, e.g., hydrochloric acid, sulfuric acid, acetic acid, or a combination thereof. The solvent may be an aqueous solution with a concentration of about 0.05 M to about 0.5 M.

An added amount of the carbon material may be, e.g., per about 10 ml of the solvent, about 0.1 g to about 10 g, about 0.2 g to about 10 g or about 0.5 g to about 5 g.

After adding the carbon material to the acidic solvent, an agitating may be performed at a speed of about 200 rpm to about 1,000 rpm, about 300 rpm to about 1,000 rpm, or about 500 rpm to about 1,000 rpm for about 10 minutes to about 1 hour, or about 20 minutes to about 40 minutes.

The addition of the hydrogen silsesquioxane precursor may be performed by agitating at a speed of about 200 rpm to about 1,000 rpm, about 300 rpm to about 1,000 rpm, or about 500 rpm to about 1,000 rpm.

The hydrogen silsesquioxane precursor may include, e.g., triethoxysilane, trimethoxysilane, vinyltrimethoxysilane, vinyltriethoxysilane, γ-methacryloxy propyltrimethoxysilane, γ-methacryloxy propyltriethoxysilane, or a combination thereof.

An added amount of the hydrogen silsesquioxane precursor may be adjusted until the weight ratio of shell/core in a primary heat-treated product becomes, e.g., about 1:100 to about 30:100, about 5:100 to about 25:100, or about 10:100 to about 20:100.

According to the mixing, a sol-gel reaction may occur, thereby preparing a product in which the surface of the carbon material is coated with the hydrogen silsesquiloxane precursor.

Thereafter, the resulting product may be primary heat-treated. The primary heat-treatment may be carried out by increasing a temperature to about 800° C. to about 1,500° C., or about 900° C. to about 1,300° C. at an increasing rate of about 1° C./minute to about 20° C./minute, or about 2° C./minute to about 15° C., and maintaining such a temperature for about 0.5 hours to about 5 hours, or about 0.5 hours to about 3 hours. The primary heat-treatment may be carried out under an inert atmosphere. In an implementation, the atmosphere may include, e.g., an argon atmosphere, nitrogen atmosphere, hydrogen atmosphere, a mixture thereof.

According to the primary heat-treatment, the hydrogen silsesquioxane precursor may decompose to produce silicon, thereby preparing a product in which a silicon shell is on the surface of a carbon material core. In an implementation, the heat treatment temperature may be adjusted in the step, and the shell including silicon together with SiO_{z} (0<z≤2) may be prepared.

The primary heat-treated product may be mixed with a lithium source material. The lithium source material may be LiH, LiOH, Li₂CO₃, Li₂O, LiCl, or a combination thereof. A mixing ratio of the primary heat-treated product and the lithium source material may be adjusted in order to have a mole ratio of Li/Si to be about 1.5/1 to about 2.0/1, or about 1.75/1 to about 2.0/1.

The mixing may be carried out by using a ball mill. In an implementation, the ball mill may use zirconia balls.

Before mixing with the lithium source material, forming an amorphous carbon coating layer on the primary heat-treated product may be further performed.

The formation of the coating layer may be carried out by mixing the primary heat-treated product with an amorphous carbon precursor and heat-treating. The amorphous carbon precursor may include, e.g., petroleum coke, coal coke, petroleum pitch, coal pitch, pitch carbon, green cokes, or a combination thereof.

A mixing ratio of the primary heat-treated product and the amorphous carbon precursor may be a weight ratio of about 7:3 to about 9.5: about 0.5.

The mixing may be performed in a solvent, e.g., tetrahydrofuran, methanol, ethanol, propanol, water, or a combination thereof. The mixing may be performed at about 40° C. to about 80° C., or about 50° C. to about 70° C. and at a speed of about 100 rpm to about 200 rpm, or about 110 rpm to about 150 rpm, until the solvent is substantially and mostly removed.

After mixing with the amorphous carbon precursor, the heat treatment may be carried out by increasing a temperature at an increasing rate of about 1° C./minute to about 10° C./minute, or about 2° C./minute to about 8° C./minute to about 500° C. to about 1,000° C., or about 600° C. to about 900° C. and maintaining that temperature for about 1 hour to about 8 hours, or about 1 hour to about 5 hours.

The resulting product may be secondary heat-treated.

The secondary heat treatment process may be carried out by increasing a temperature at an increasing rate of about 1° C./minute to about 20° C./minute, or about 2° C./minute to about 15° C./minute to about 500° C. to about 1,000° C., or about 600° C. to about 900° C. and maintaining that temperature for about 1 hour to about 10 hours, or about 2 hours to about 8 hours. The secondary heat-treatment may be carried out under an inert atmosphere. In an implementation, the atmosphere may be, e.g., an argon atmosphere, a nitrogen atmosphere, a hydrogen atmosphere, or a mixture thereof.

According to the secondary heat-treatment, lithium ions derived from the lithium source material may react with some of silicon of the silicon shell to generate lithium silicates such as Li₂SiO₃, Li₂Si₂O₅, Li₄SiO₄, or the like. The remaining silicon (which is not reacted) may be positioned on the core, and SiO_{z} (0<z≤2) may remain.

In an implementation, the formation of the amorphous carbon coating layer may be further performed, and some lithium ions derived from the lithium source material may also react with amorphous carbon to generate lithium carbonate (Li₂CO₃).

The obtained heat-treated product may be washed and dried to prepare a negative electrode active material. The washing may be carried out using water or a weak acidic solvent. In an implementation, the washing may be performed, e.g., using a weak acidic solvent. The weak acidic solvent may include, e.g., phosphoric acid (H₃PO₄), acetic acid, or a combination thereof.

The washing may remove lithium carbonate and Li₄SiO₄. Resultantly, the final negative electrode active material may include a core including a carbon material, and Si and silicate on the surface of the core.

Another embodiment may provide a rechargeable lithium battery including a negative electrode, a positive electrode, and an electrolyte.

The negative electrode may include a current collector, and a negative electrode active material layer on the current collector and including a negative electrode active material layer including the negative electrode active material according to one or more embodiments.

In the negative electrode active material, an amount of the negative electrode active material may be about 95 wt % to about 98 wt %, based on the total weight of the negative electrode active material layer.

In an implementation, the negative electrode active material layer may include a binder, and may further include a conductive material. The amount of the binder may be about 1 wt % to about 5 wt %, based on the total weight of the negative electrode active material layer. The amount of the conductive material may be about 1 wt % to about 5 wt %, based on the total weight of the negative electrode active material layer.

The binder helps improve binding properties of negative electrode active material particles with one another and with a current collector. The binder may include a non-aqueous binder, an aqueous binder, or combination thereof.

The non-aqueous binder may include, e.g., an ethylene propylene copolymer, polyacrylonitrile, polystyrene, polyvinyl chloride, carboxylated polyvinylchloride, polyvinyl fluoride, polyurethane, polytetrafluoroethylene, polyvinylidene fluoride, polyethylene, polypropylene, polyamide imide, polyimides, or combinations thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluorine rubber, polyethylene oxide, polyvinyl pyrrolidone, polypropylene, polyepichlorohydrin, polyphosphazene, an ethylene propylene diene copolymer, polyvinyl pyridine, chlorosulfonated polyethylene, latex, a polyester resin, an acrylic resin, a phenolic resin, an epoxy resin, polyvinyl alcohol, or combinations thereof.

The negative electrode binder may include a cellulose compound and may include the cellulose compound together with the aqueous binder. The cellulose compound may include, e.g., carboxymethyl cellulose, hydroxypropylmethyl cellulose, methyl cellulose, or alkali metal salts thereof. The alkali metal may be Na, K, or Li. The cellulose compound may serve as a binder and may impart viscosity to serve as a thickener. An amount of the cellulose compound may be appropriately adjusted within the amount of the binder, e.g., it may be about 0.1 parts by weight to about 3 parts by weight based on 100 parts by weight of the negative electrode active material.

The conductive material may be included to provide electrode conductivity, and a suitable electrically conductive material that does not cause a chemical change may be used as a conductive material. Examples of the conductive material may include a carbon material such as natural graphite, artificial graphite, carbon black, acetylene black, ketjen black, a carbon fiber, or the like; a metal material of a metal powder or a metal fiber including copper, nickel, aluminum, silver, or the like; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, or a combination thereof.

The positive electrode may include a current collector and a positive electrode active material layer on the current collector.

The positive electrode active material may include lithiated intercalation compounds that reversibly intercalate and deintercalate lithium ions. In an implementation, one or more composite oxides of a metal, e.g., cobalt, manganese, nickel, and a combination thereof, or lithium, may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0<α≤2); LiₐNi^{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}G_{c}O₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the above chemical formulars, A may be, e.g., Ni, Co, Mn, or a combination thereof; X may be, e.g., Al, Ni, Co, Mn, Cr, Fe, Mg, Sr, V, a rare earth element, or a combination thereof; D¹ may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z may be, e.g., Cr, V, Fe, Sc, Y, or a combination thereof; J may be, e.g., V, Cr, Mn, Co, Ni, Cu, or a combination thereof; L¹ may be, e.g., Mn, Al, or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be disposed or formed using a method having no adverse influence on properties of a positive electrode active material by using these elements in the compound, e.g., spray coating, dipping, or the like.

In the positive electrode, an amount of the positive electrode active material may be about 90 wt % to about 98 wt %, based on the total weight of the positive electrode active material layer.

In an implementation, the positive electrode active material layer may further include a binder and a conductive material. The binder and the conductive material may be included in an amount of about 1 wt % to about 5 wt %, respectively based on the total weight of the positive electrode active material layer.

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may be included to provide electrode conductivity, and a suitable electrically conductive material that does not cause a chemical change may be used as a conductive material. Examples of the conductive material may include a carbon material such as natural graphite, artificial graphite, carbon black, acetylene black, ketjen black, a carbon fiber, or the like; a metal material of a metal powder or a metal fiber including copper, nickel, aluminum, silver, or the like; a conductive polymer such as a polyphenylene derivative; or a mixture thereof.

The current collector may include Al.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dibutyl acetate, methyl propionate, ethyl propionate, decanolide, mevalonolactone, caprolactone, or the like.

The ether solvent may include dibutyl ether, tetraglyme, diglyme, dimethoxyethane, 2-methyltetrahydrofuran, tetrahydrofuran, or the like. The ketone solvent may include cyclohexanone, or the like. The alcohol solvent may include ethanol, isopropyl alcohol, or the like. The aprotic solvent may include nitriles such as R—CN (wherein R is a C2 to C20 linear, branched, or cyclic hydrocarbon group, and may include a double bond, an aromatic ring, or an ether bond, or the like); amides such as dimethylformamide;

dioxolanes such as 1,3-dioxolane, and the like; sulfolanes, or the like.

The organic solvent may be used alone or in a mixture. In an implementation, the organic solvent may be used in a mixture, and the mixture ratio may be controlled in accordance with a desirable battery performance.

The carbonate solvent may include a mixture with a cyclic carbonate and a linear carbonate. The cyclic carbonate and linear carbonate may be mixed together in a volume ratio of about 1:1 to about 1:9, and it may provide enhanced performance.

The organic solvent may further include an aromatic hydrocarbon solvent as well as the carbonate solvent. The carbonate solvent and aromatic hydrocarbon solvent may be mixed together in a volume ratio of about 1:1 to about 30:1.

The aromatic hydrocarbon organic solvent may include, e.g., an aromatic hydrocarbon compound represented by Chemical Formula 1.

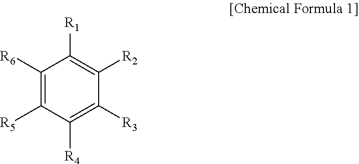

In Chemical Formula 1, R₁ to R₆ may each independently be or include, e.g., hydrogen, a halogen, a C1 to C10 alkyl group, a haloalkyl group, or a combination thereof.

Examples of the aromatic hydrocarbon organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylethyl carbonate, vinylene carbonate, or an ethylene carbonate compound represented by Chemical Formula 2 as an additive for improving cycle life.

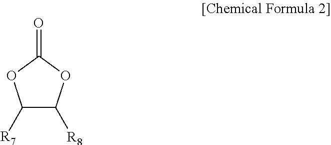

In Chemical Formula 2, R₇ and R₈ may each independently be or include, e.g., hydrogen, a halogen, a cyano group (CN), a nitro group (NO₂), or a C₁ to C₅ fluoroalkyl group. In an implementation, at least one of R₇ and R₈ may be a halogen, a cyano group (CN), a nitro group (NO₂), or a C₁ to C₅ fluoroalkyl group, and R₇ and R₈ are not simultaneously hydrogen.

Examples of the ethylene carbonate compound may include difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or the like. An amount of the additive for improving the cycle-life characteristics may be within a suitable range.

The lithium salt dissolved in an organic solvent may supply a battery with lithium ions, may basically operate the rechargeable lithium battery, and may help improve transportation of the lithium ions between a positive electrode and a negative electrode. Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of about 1 to about 20, lithium difluoro(bisoxolato) phosphate), LiCl, LiI, LiB(C₂O₄)₂ (lithium bis(oxalato) borate (LiBOB) or lithium difluoro(oxalato)borate (LiDFOB). A concentration of the lithium salt may range from about 0.1 M to about 2.0 M. Maintaining the concentration of the lithium salt within the above concentration range may help ensure that an electrolyte may have excellent performance and lithium ion mobility due to optimal electrolyte conductivity and viscosity.

A separator may be between the positive electrode and the negative electrode, depending on a type of a rechargeable lithium battery. The separator may include, e.g., polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and the like.

The FIGURE is an exploded perspective view of a rechargeable lithium battery according to an embodiment. As illustrated in the drawing, the rechargeable lithium battery according to some embodiments may be a prismatic battery, or may include variously-shaped batteries such as a cylindrical battery, a pouch battery, or the like.

Referring to the FIGURE, a rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20 and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### <Preparation of Negative Electrode Active Material>

### Step 1)

5 g of artificial graphite powder was added to 50 ml of a 0.1 M HCl aqueous solution and shaken at 700 rpm for 30 minutes to prepare a dispersed liquid. Thereafter, as the dispersed liquid was continuously shaken at 700 rpm, triethoxysilane (TES) was added to the dispersed liquid and reacted for 30 minutes.

The amount of triethoxysilane added was adjusted in order to prepare a primarily heat-treated product including the shell/core at a weight ratio of 20/100 wt %. The resulting product was filtered with a filter to separate the acidic solvent and dried at 80° C. for one day in a convection oven (horizontal furnace).

The dried powder was primarily heat-treated in the horizontal furnace by increasing the temperature at an increasing rate of 10° C./min to 1,000° C. and maintaining at that temperature for 1 hour under a mixed atmosphere of argon and hydrogen (96 volume % of argon and 4 volume % of hydrogen).

Thereafter, the primarily heat-treated powder was collected and pulverized to prepare a product including a graphite core and a shell including silicon and SiO_{z} (in which 0<z≤2).

### Step 2)

The product was mixed with pitch carbon at a weight ratio of 9:1 in tetrahydrofuran (THF) and shaken at 120 rpm and at 60° C. until the solvent was dried.

The resulting mixture was pulverized and heat-treated by increasing a temperature at an increasing rate of 5° C./min to 800° C. and maintaining at 800° C. for 2 hours under an argon gas atmosphere, thereby preparing a product including an amorphous carbon coating layer.

### Step 3)

The product was mixed with LiH powder, zirconia balls (10 times by weight of the mixed powder) was added to the mixture, and then vigorously mixed for 30 minutes. The LiH was used at an amount of 0.116 g in order to have a mole ratio of Li/Si of 2.0. The obtained mixture was sieved using a sieve of 500 μm. The sieved product was secondarily heat-treated by increasing a temperature at an increasing rate of 10° C./min to 750° C. and maintaining at 750° C. for 6 hours under an argon atmosphere and pulverized to prepare a product including a graphite core and a shell including silicon oxide (SiOₓ), silicon (Si), and lithium silicates (Li₂SiO₃, Li₂Si₂O₅, Li₄SiO₄ or the like).

### Step 4)

A washing was carried out by adding 1 g of the prepared product to 100 mL of distilled water, shaking for 30 minutes, and filtering with a filter. The resulting powder was dried in a vacuum oven for one day to prepare a negative electrode active material in which Li₄SiO₄ and Li₂CO₃ phases were removed, and a graphite core, a porous shell on the core, including Li₂SiO₃, Li₂Si₂O₅, Si, and SiO_{z} (in which 0<z≤2), and an amorphous carbon layer on the porous shell were included.

In the prepared negative electrode active material, a weight ratio of Li₂SiO₃ and Li₂Si₂O₅:Si was 1:99, and an amount of Li₂SiO₃ and Li₂Si₂O₅ was 0.2 wt % based on the total weight of the negative electrode active material. In the prepared negative electrode active material, a thickness of the shell was 100 nm to 400 nm and a thickness of the amorphous carbon layer was 1 nm.

### <Preparation of Negative Electrode>

90 wt % of the prepared negative electrode active material, 5 wt % of carboxymethyl cellulose, and 5 wt % of a styrene butadiene rubber were mixed in a water solvent to prepare a negative electrode active material layer slurry.

The negative electrode active material layer slurry was coated on a Cu foil current collector, vacuum-dried at 120° C. for 2 hours, and pressed to form a negative electrode active material layer with a 30 μm thickness, thereby preparing a negative electrode.

A polyethylene separator was disposed between the negative electrode and a lithium metal counter electrode and then an electrolyte was injected to fabricate a CR2032 coin cell. The electrolyte was prepared by adding 2 wt % of fluoroethylene carbonate to 100 wt % of a 1 M LiPF₆ solution in a mixed solvent of ethylene carbonate and ethylmethyl carbonate (a mixing ratio of ethylene carbonate:ethylmethyl carbonate-3:7 volume ratio).

### Example 2

A negative electrode active material was prepared by the same procedure as in Example 1, except that in mixing of the product and the LiH powder, LiH was used in an amount of 0.102 g in order to have a mole ratio of Li/Si of 1.75. In the prepared negative electrode active material, a weight ratio of Li₂SiO₃ and Li₂Si₂O₅:Si was 2:98, and an amount of Li₂SiO₃ and Li₂Si₂O₅ was 0.4 wt % based on the total weight of the negative electrode active material. In the prepared negative electrode active material, a thickness of the shell was 100 nm to 400 nm and a thickness of the amorphous carbon layer was 1 nm.

The negative electrode active material was used to fabricate a negative electrode and a half-cell by the same procedure as in Example 1.

### Example 3

A negative electrode active material was prepared by the same procedure as in Example 1, except that in mixing of the product and the LiH powder, an amount of LiH was used at 0.087 g in order to have a mole ratio of Li/Si of 1.5. In the prepared negative electrode active material, a weight ratio of Li₂SiO₃ and Li₂Si₂O₅:Si was 3:97, and an amount of Li₂SiO₃ and Li₂Si₂O₅ was 0.6 wt % based on the total weight of the negative electrode active material. In the prepared negative electrode active material, a thickness of the shell was 100 nm to 400 nm and a thickness of the amorphous carbon layer was 1 nm.

The negative electrode active material was used to fabricate a negative electrode and a half-cell by the same procedure as in Example 1.

### Comparative Example 1

97.5 wt % of an artificial graphite negative electrode active material, 1 wt % of carboxymethyl cellulose, and 0.5 wt % of a styrene butadiene rubber were mixed in a water solvent to prepare a negative electrode active material layer slurry.

The negative electrode active material layer slurry was coated on a Cu foil current collector, dried, and pressed to prepare a negative electrode active material layer, thereby preparing a negative electrode.

### Comparative Example 2

A negative electrode active material was prepared by the same procedure as in Example 1, except that in mixing of the product and the LiH powder, an amount of LiH was used at 0.058 g in order to have a mole ratio of Li/Si of 1. In the prepared negative electrode active material, a weight ratio of Li₂SiO₃ and Li₂Si₂O₅:Si was 76:24, and an amount of Li₂SiO₃ and Li₂Si₂O₅ was 15.2 wt % based on the total weight of the negative electrode active material. In the prepared negative electrode active material, a thickness of the shell was 100 nm to 400 nm and a thickness of the amorphous carbon layer was 1 nm.

The negative electrode active material was used to fabricate a negative electrode and a half-cell by the same procedure as in Example 1.

### Comparative Example 3

A negative electrode active material was prepared by the same procedure as in Example 1, except that in mixing of the product and the LiH powder, an amount of LiH was used at 0.073 g in order to have a mole ratio of Li/Si of 1.25. In the prepared negative electrode active material, a weight ratio of Li₂SiO₃ and Li₂Si₂O₅:Si was 59:41, and an amount of Li₂SiO₃ and Li₂Si₂O₅ was 7.4 wt % based on the total weight of the negative electrode active material. In the prepared negative electrode active material, a thickness of the shell was 100 nm to 400 nm and a thickness of the amorphous carbon layer was 1 nm.

The negative electrode active material was used to fabricate a negative electrode and a half-cell by the same procedure as in Example 1.

### Experimental Example 1) Evaluation of Electrochemical Characteristic

The half-cells according to Examples 1 to 3 and the Comparative Examples 1 to were formation charged and discharged at 25° C. and at 0.1 C (1 C=360 mAh/g) for 5 cycles. The formation charged and discharged cells were constant current charged at 0.1 C until the voltage reached 0.01 V, followed by a constant voltage charge with a cut-off at a current of 0.01 C while maintaining 0.01 V under a constant voltage mode. Thereafter, until the voltage reached 2.0 V (vs. Li), discharged at 0.1 C was carried out, and constant current charge at 0.5 C was carried out until voltage reached 0.01 V, followed by a constant voltage charge with a cut-off at a current of 0.05 C while maintaining 0.01 V under a constant voltage mode. Thereafter, until the voltage reached 2.0 V (vs. Li), discharged was proceeded at a constant current of 0.5 C.

After measuring charge capacity and discharge capacity, an initial efficiency (percentage of discharge capacity/charge capacity) was calculated from these results. The results are shown in Table 1.

TABLE 1

| | Li/Si | Charge | Discharge | Initial |
|---|---|---|---|---|
| | mole | capacity | capacity | efficiency |
| | ratio | (mAh/g) | (mAh/g) | (%) |
| Comparative | — | 349 | 332 | 95 |
| Example 1 | | | | |
| Comparative | 1.0 | 372 | 314 | 84.6 |
| Example 2 | | | | |
| Comparative | 1.25 | 393 | 338 | 85.9 |
| Example 3 | | | | |
| Example 3 | 1.5 | 462 | 401 | 86.7 |
| Example 2 | 1.75 | 471 | 410 | 87.0 |
| Example 1 | 2.0 | 483 | 421 | 87.2 |

As shown in Table 1, the cells of Examples 1 to 3 exhibited suitable initial efficiency, and high charge and discharge capacity. Comparative Example 1 exhibited high initial efficiency, and low charge and discharge capacity. Comparative Examples 2 and 3 exhibited both lower initial efficiency and charge and discharge capacity, when compared with Examples 1 to 3.

### Experimental Example 3) Evaluation of Cycle-Life Characteristic

The half-cells according to Examples 1 to 3 and Comparative Examples 1 to 3 were charged and discharged at 0.5 C for 250 cycles and a ratio of the discharge capacity at 250^{th} cycle relative to discharge capacity at 1^{st} cycle was calculated. The results are shown in Table 2, as capacity retention.

### Experimental Example 4) Evaluation of Coulomb Efficiency

The half-cells according to Examples 1 to 3 and Comparative Examples 1 to 3 were charged and discharged 250 cycles at 0.1 C (36 mAh/g) for up to 5 cycles and at 0.5 C (180 mAh/g) from the 6^{th} cycle, and then coulomb efficiency was measured. The results are shown in Table 2.

TABLE 2

| | Li/Si mole | Capacity retention | Coulomb efficiency |
|---|---|---|---|
| | ratio | (%) | (%) |
| Comparative | — | 94.7 | 99.9 |
| Example 1 | | | |
| Comparative | 1.0 | 96.2 | 99.8 |
| Example 2 | | | |
| Comparative | 1.25 | 97.3 | 99.9 |
| Example 3 | | | |
| Example 3 | 1.5 | 99.5 | 99.8 |
| Example 2 | 1.75 | 99.3 | 99.9 |
| Example 1 | 2.0 | 99.1 | 99.9 |

As shown in Table 2, Examples 1 to 3 exhibited high coulomb efficiency (similar to Comparative Examples 1 to 3) and superior capacity retention compared to Comparative Examples 1 to 3.

By way of summation and review, crystalline carbon, e.g., graphite, may be used as a negative electrode active material for the negative electrode.

One or more embodiments may provide a negative electrode active material exhibiting excellent cycle-life characteristics and fast charge performance.

A negative electrode active material according to one or more embodiments may exhibit excellent rate characteristic and efficiency.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
a core comprising a carbon material, a silicon material, or a combination thereof; and
a shell on a surface of the core, the shell comprising Si and LiₓSiO_{y}, in which 1≤x≤3 and 1≤y≤6.

2. The negative electrode active material as claimed in claim 1, wherein the shell further comprises SiO_{z}, in which 0<z≤2.

3. The negative electrode active material as claimed in claim 1, wherein the shell is on the surface of the core in a form of an island-type or a layer-type.

4. The negative electrode active material as claimed in claim 3, wherein the shell is on the surface of the core in the form of the island-type.

5. The negative electrode active material as claimed in claim 1, wherein the negative electrode active material has a pH of about 7 or less.

6. The negative electrode active material as claimed in claim 1, wherein the carbon material comprises amorphous carbon, crystalline carbon, or a combination thereof.

7. The negative electrode active material as claimed in claim 1, wherein the silicon material comprises a Si—C composite.

8. The negative electrode active material as claimed in claim 7, wherein the Si—C composite comprises:
silicon particles, and
an amorphous carbon layer on a surface of the silicon particles.

9. The negative electrode active material as claimed in claim 7, wherein the Si—C composite comprises:
a secondary particle in which silicon primary particles are agglomerated, and
an amorphous carbon coating layer on a surface of the secondary particle.

10. The negative electrode active material as claimed in claim 1, further comprising an amorphous carbon coating layer on the shell.

11. The negative electrode active material as claimed in claim 1, wherein the shell has a thickness of about 100 nm to about 500 nm.

12. The negative electrode active material as claimed in claim 1, wherein the shell is porous.

13. The negative electrode active material as claimed in claim 1, wherein a weight ratio of the LiₓSiO_{y} and Si is about 1:99 to about 77:23.

14. The negative electrode active material as claimed in claim 13, wherein a weight ratio of the LiₓSiO_{y} and Si is about 1:99 to about 75:25.

15. The negative electrode active material as claimed in claim 1, wherein an amount of the LiₓSiO_{y} is about 0.1 wt % to about 15 wt %, based on a total weight of the negative electrode active material.

16. The negative electrode active material as claimed in claim 1, wherein an amount of the LiₓSiO_{y} is about 0.1 wt % to about 10 wt % based on a total weight of the negative electrode active material.

17. A rechargeable lithium battery, comprising:
a negative electrode comprising the negative electrode active material as claimed in claim 1;
a positive electrode; and
an electrolyte.
